(19) United States
(12) Patent Application Publication
(10) Pub. No.: US 2015/0210105 A1
(43) Pub. Date: Jul. 30, 2015

(54) CARD WITH MARBLED VISUAL EFFECT AND ASSOCIATED MANUFACTURING PROCESS

(71) Applicant: GEMALTO S.A., Meudon (FR)

(72) Inventors: Stephane Karafotis, Gemalto (FR); Sebastien Subra, Meudon (FR)

(73) Assignee: GEMALTO SA, Meudon (FR)

(21) Appl. No.: 14/419,240

(22) PCT Filed: Sep. 5, 2013
(86) PCT No.: PCT/EP2013/068386

§ 371 Date: Feb. 2, 2015

(30) Foreign Application Priority Data
Sep. 5, 2012 (EP) 12306057.6

(51) Int. Cl. B42D 25/22; B42D 25/45; B42D 25/23; B05D 3/06; B32B 38/00

(52) U.S. Cl. CPC B42D 25/22; B05D 3/067; B32B 38/145; B42D 25/23; B42D 25/45; B32B 2307/404; B32B 2333/04; B32B 2425/00

(57) ABSTRACT

This invention concerns a card with a marbled visual effect, said card comprising at least one substrate layer comprising a first and a second side, wherein said substrate layer is covered with a translucent protective layer, wherein a pattern cracked by lamination is printed on at least one of the sides of the substrate layer so that the colour located underneath said pattern can be seen through the cracks.

This invention concerns the graphics personalisation of documents, particularly the graphics personalisation of multilayer documents such as cards to the ISO 7810 standard so as to give them a marbled visual effect.

In order to create a marbled visual effect on a multilayer document, there is a known process for reproducing on each document a marbled pattern made up of at least two colours by means of printing. However, the pattern is identical for each printed document, and its rendering may be affected by the treatment and protection that is subsequently applied to the document.

Another known means for creating a marbled visual effect is to print a first pattern on the document followed by the printing of a second pattern with ink, which, when the solvents contained in it evaporate, forms cracks through which the first pattern can be seen. The marbled visual effect in this case is random and its rendering may also be affected by the treatment and protection applied subsequently to the document. Further, the use of ink comprising solvents that allow the formation of cracks can lead to additional manufacturing costs because a drying time is required for the solvents to evaporate so that the marbled visual effect is satisfactory.

One of the aims of this invention is thus to remedy at least some of the drawbacks of the prior art and to propose a card, particularly to the ISO 7810 standard, with a marbled effect that is durable, satisfactory and economical, involving limited manufacturing costs.

This invention thus concerns a card with a marbled visual effect, said card comprising at least one substrate layer comprising a first and a second side, wherein said substrate layer is covered with a translucent protective layer, wherein a cracked pattern is printed with an UV-hardened ink on at least one of the sides of the substrate layer so that the colour located underneath said pattern can be seen through the cracks.

The fact that the printing ink of the pattern is cracked when the card is laminated by thermal and mechanical treatment ensures greater durability of the marbled effect, as it is in a way frozen by the adhesion of the protective layer and unaffected when the layer is laminated.

In one aspect of the invention, the ink for printing the pattern contains:
30 to 50% hexamethylene diacrylate,
20 to 30% pentaerythritol triacrylate,
10 to 30% 2-methyl-1-4-(methylthio)pheny-2-morpholino-propan-1-one, and
1 to 20% coloured pigments.

In another aspect of the invention, the substrate layer comprises a prior pattern printed on at least one of its sides and the pattern cracked by lamination is printed directly on said prior pattern.

In another aspect of the invention, the prior pattern and the pattern are in contrasting colours.

This invention also concerns a process for manufacturing a card with a marbled visual effect, said process comprising the following steps:
supply of a substrate layer comprising a first and a second side,
printing of a pattern on at least one of the sides of the substrate layer with an UV-hardening ink,
exposing the pattern to UV rays to cause the ink to harden,
application of a protective layer,
lamination of the card so as to join the different layers to each other and to crack the ink of the pattern so as to make the colour located underneath said pattern visible through the cracks of the second pattern.

The fact that the cracks are formed during the standard step of laminating the card makes it possible to integrate the formation of cracks and thus the marbled visual effect into the standard manufacturing process and thus limit the costs of manufacturing and of creating the visual marbled effect.

In one aspect of the process, the ink for printing the pattern contains:
30 to 50% hexamethylene diacrylate,
20 to 30% pentaerythritol triacrylate,
10 to 30% 2-methyl-1-4-(methylthio)pheny-2-morpholino-propan-1-one, and
1 to 20% coloured pigments.

In another aspect of the process, following the step in which the pattern is printed, said pattern undergoes an ultraviolet exposure step.

In another aspect of the process, the substrate layer comprises a prior pattern printed on at least one of its sides and the pattern cracked by lamination is printed directly on said prior pattern.

In another aspect of the process, the lamination step comprises at least the following:
a first treatment at temperature ranging from 110 to 150° C. with pressure of 80 to 120 N/cm² for 10 to 20 min,
a second treatment at temperature ranging from 16 to 20° C. with pressure of 180 to 220 N/cm² for 10 to 20 min.

In another aspect of the process, the pattern is printed by ink jet printing.

In another aspect of the process, ultraviolet exposure is carried out simultaneously with the printing of the pattern.

Other characteristics and benefits of the invention will become clearer in the description below, provided as an illustrative and non-limitative example, and the attached drawings, where:

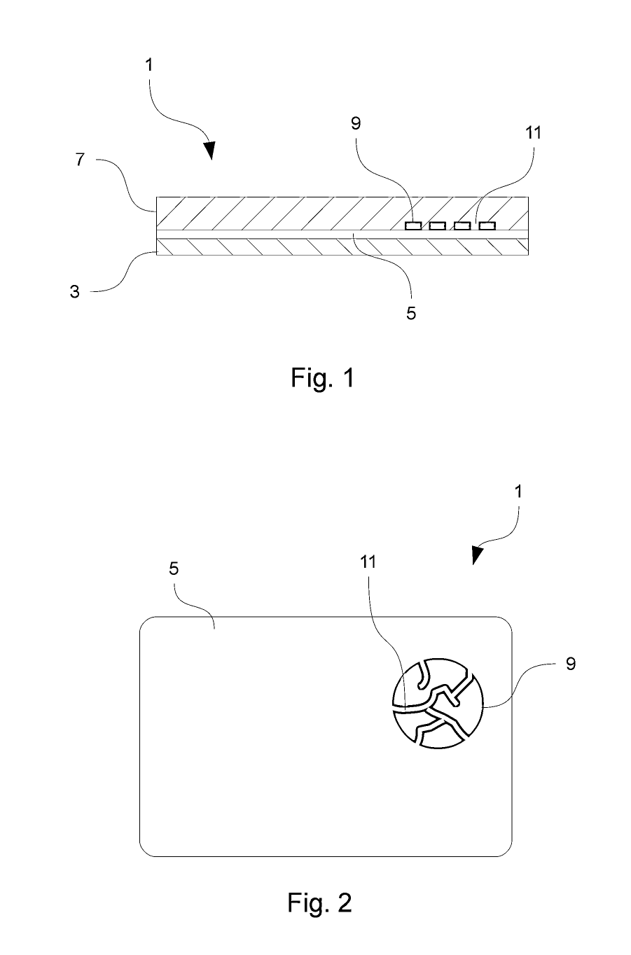

FIG. 1 is a schematic sectional representation of a card according to the invention,

FIG. 2 is a schematic representation of the top view of the card in FIG. 1.

In the different figures, identical elements bear the same reference numbers.

FIG. 1 is a schematic sectional representation of a card 1 to standard ISO 7810. That card 1 may for example be a bank card for payment, an identification card, an identity card or a magnetic card, a smart card or a Near Field Communication (NFC) card.

The card 1 comprises a substrate layer 3 comprising a first and a second side. On at least one of the first and second sides, a prior pattern 5 may be printed. The substrate layer 3 may be made up of only one layer or comprise different superposed layers that make up the card 1, for example by incorporating a chip and an NFC antenna. The prior pattern 5 is a standard pattern print, known to the person of the art and usually created during a step for the graphics personalisation of a card 1. The prior pattern 5 may cover all or part of the substrate layer 3.

A pattern 9 cracked by lamination is printed on at least one of the sides of the substrate layer 3. If the substrate layer 3 comprises a prior pattern 5, the pattern 3 may be printed directly on said prior pattern 5. The cracks 11 of the pattern 9 are such that the colour located underneath said pattern 9 can be seen through the cracks in order to create the marbled visual effect. For that marbled visual effect to be more noticeable, contrasting colours may be used for the different patterns 5 and 9 or the pattern 9 may be printed in colour that contrasts with that of the substrate layer 3, when it is printed directly on it. The pattern 9 may cover all or part of the prior pattern 5 or the substrate layer 3. For security use, the difference between the inks of the two different patterns can be under particular lighting condition, one of the inks can change of colour in a non-visible spectrum.

The substrate layer 3 and the different patterns 5, 9 are generally covered with a translucent protective layer 7. FIG. 2 shows the card 1 of FIG. 1 in a top view with the pattern 9 and the prior pattern 5 visible through the protective layer 7. The colour of the prior pattern 5 can be seen through the cracks 11.

The printing ink used to make the pattern 9 is advantageously formulated to contain:
30 to 50% hexamethylene diacrylate, CAS (Chemical Abstracts Service) reference 13048-33-8,
20 to 30% pentaerythritol triacrylate, CAS reference 3524-68-3,
10 to 30% de 2-methyl-1-4-(methylthio)pheny-2-morpholino-propan-1-one, CAS reference 71868-10-5, and
1 to 20% coloured pigments.

Hexamethylene acrylate is a polymerising compound that is commonly used in the area of inks in order to reinforce the bonding of the ink. For its part, pentaerythritol triacrylate is a hardener that makes it possible to make the printing more resistant. 2-methyl-1-4-(methylthio) pheny-2-morpholino-propan-l-one is an ultraviolet polymerisation photo initiator. Lastly, the coloured pigments are elements that give colour to the ink used for printing the pattern 9. These coloured pigments may for example be carbon black in a 1 to 5% proportion in the formulation of ink for black colour or titanium dioxide in a 10 to 20% proportion in the formulation of ink for white colour.

The ink used for printing the pattern 9 as formulated above is cured by UV exposure and does not form cracks 11 during the hardening process. The cracks 11 are made by thermal and mechanical treatment applied to the pattern 9. The treatment is advantageously carried out by the treatment for laminating the card 1 in order to bond the different layers that make it up to each other, particularly for the bonding of the protective layer 7. The fact that the printing ink of the pattern 9 is cracked when the card 1 is laminated by thermal and mechanical treatment ensures greater durability of the marbled effect, as it is in a way frozen by the adhesion of the protective layer 7 and unaffected when the layer is laminated.

The invention also concerns a process for manufacturing a card 1 with a marbled visual effect comprising the following steps:

A step of supplying the substrate layer 3 as described above, at least one side of which may comprise a printed prior pattern 5.

A step of printing the pattern 9 on at least part of at least one of the sides of the substrate layer or the first pattern 5 using ink formulated as follows:
30 to 50% hexamethylene diacrylate, CAS (Chemical Abstracts Service) reference 13048-33-8,
20 to 30% pentaerythritol triacrylate, CAS reference 3524-68-3,
10 to 30% de 2-methyl-1-4-(methylthio)pheny-2-morpholino-propan-1-one, CAS reference 71868-10-5, and
1 to 20% coloured pigments.

Advantageously, that second printing step is carried out by ink jet printing.

A step of exposing the pattern 9 to UV rays to cause the ink to harden.

A step of applying a protective layer 7 on the printed side or sides of the substrate layer 3.

And lastly a step of laminating the card 1 is performed. During that laminating step, the different layers, particularly the substrate layer 3 and the protective layer or layers 7 are joined to each other. The temperature is increase under pressure for insuring a good sticking between the layers. Further, that lamination step leads to the formation of cracks 11 on the pattern 9 in order to make the colour underneath said pattern 9 visible through said cracks 11.

The fact that the cracks 11 are formed during the standard lamination step of laminating a multilayer card 1 makes it possible to integrate the formation of cracks 11 and thus the marbled visual effect into the standard manufacturing process and thus limit the costs of manufacturing and of creating the visual marbled effect. The costs are all the more limited because the UV exposure step can be carried out simultaneously with the printing of the pattern 9.

Preferentially and in order to enlarge cracks 11 that improves the visual effect with the colour located underneath the pattern 9 while bonding the different layers to each other, the lamination treatment comprises:
a first treatment at temperature ranging from 110 to 150° C. with pressure of 80 to 120 N/cm² for 10 to 20 min,
a second treatment at temperature ranging from 16 to 20° C. with pressure of 180 to 220 N/cm² for 10 to 20 min.

Thus, it can be seen that because of the use of ink with a particular formulation for printing the pattern 9 and the formation of cracks 11 during the standard lamination step, the card 1 is given a durable marbled visual effect and that the manufacturing process limits the costs of creating such a marbled visual effect.

1. A card with a marbled visual effect, said card comprising at least one substrate layer comprising a first and a second side, wherein said substrate layer is covered with a translucent protective layer, wherein a cracked pattern is printed with an UV hardened ink on at least one of the sides of the substrate layer so that the colour located underneath said pattern can be seen through the cracks.

2. A card according to claim 1, wherein the ink for printing the pattern contains:
30 to 50% hexamethylene diacrylate,
20 to 30% pentaerythritol triacrylate,
10 to 30% 2-methyl-1-4-(methylthio)pheny-2-morpholino-propan-1-one, and
1 to 20% coloured pigments.

3. A card according to claim 1, wherein the substrate layer comprises a prior pattern printed on at least one of its sides and that the pattern cracked by lamination is printed directly on said prior pattern.

4. A card according to claim 1, wherein the prior pattern and the pattern are in contrasting colours.

5. A process for manufacturing a card with a marbled visual effect, said process comprising the following steps:
supply of a substrate layer comprising a first and a second side,
printing of a pattern on at least one of the sides of the substrate layer with an UV hardening ink,
exposing the pattern to UV rays to cause the ink to harden,
application of a protective layer on the printed side or sides of the substrate layer,
lamination of the card so as to join the different layers to each other and to crack the ink of the pattern so as to make the colour located underneath said pattern visible through the cracks of the pattern.

6. A manufacturing process according to claim 5, wherein the ink for printing the pattern contains:
30 to 50% hexamethylene diacrylate,
20 to 30% pentaerythritol triacrylate,
10 to 30% 2-methyl-1-4-(methylthio)pheny-2-morpholino-propan-1-one, and
1 to 20% coloured pigments.

7. A manufacturing process according to claim 5, wherein after the step of printing the pattern, said pattern undergoes an ultraviolet exposure step.

8. A manufacturing process according to claim 5, wherein the substrate layer comprises a prior pattern printed on at least one of its sides and that the pattern printed at least in part directly on said prior pattern.

9. A manufacturing process according to claim 5, wherein the lamination step comprises at least:
a first treatment at temperature ranging from 110 to 150° C. with pressure of 80 to 120 N/cm² for 10 to 20 min,
a second treatment at temperature ranging from 16 to 20° C. with pressure of 180 to 220 N/cm² for 10 to 20 min.

10. A manufacturing process according to claim 5 wherein the pattern is printed by ink jet printing.

11. A manufacturing process according to claim 5, wherein ultraviolet exposure is carried out simultaneously with the printing of the pattern.
